(19) United States
(12) Patent Application Publication
(10) Pub. No.: US 2013/0268853 A1
(43) Pub. Date: Oct. 10, 2013

(54) MOBILE TERMINAL COMPRISING A MAN/MACHINE INTERFACE

(71) Applicants: Sylvain Gommier, Leuven (BE); Jerome Nadel, Leuven (BE)

(72) Inventors: Sylvain Gommier, Leuven (BE); Jerome Nadel, Leuven (BE)

(73) Assignee: OPTION, Leuven (BE)

(21) Appl. No.: 13/821,939

(22) PCT Filed: Sep. 9, 2011
(86) PCT No.: PCT/EP2011/065696

§ 371 Date: Jun. 17, 2013

(30) Foreign Application Priority Data
Sep. 9, 2010 (FR) 1057180

(51) Int. Cl. G06F 3/0481; G06F 3/0486

(52) U.S. Cl. CPC G06F 3/0481; G06F 3/0486
USPC 715/702; 715/781; 715/769

(57) ABSTRACT

A mobile terminal displays on a screen a panel from among a plurality of man-machine interface panels on which graphic objects relative to the applications installed on the mobile terminal may be placed. Each application is associated with at least one application category. The mobile terminal determines (4.2) at least one application category to which is associated the panel displayed on the screen, and decides (4.4) to authorize or not authorize whether the graphic objects are placed on the displayed panel, depending on the application category or categories associated with the displayed panel. A menu, comprising graphic objects relative to the applications and from which graphic objects relative to the applications installed on the mobile terminal may be installed on the displayed panel, is organized depending on the application category or categories associated with the displayed panel.

The present invention relates to a mobile terminal comprising a man-machine interface comprising a plurality of panels in which graphic objects relative to the applications installed on the mobile terminal may be placed. The present invention also relates to a method implemented by this mobile terminal. The present invention also relates to a computer program enabling the implementation of the method and storage means storing such a computer program.

Mobile terminals such as mobile telephones, PDAs (Personal Digital Assistants), multimedia readers or else tablet type personal computers (PC or Personal Computer tablet) are becoming more and more complex and offer increasingly numerous functionalities to their users. These functionalities are accessible in the form of software modules known as applications.

When a user turns on such a mobile terminal, it typically displays a home page or a home page panel. In fact, given the multitude of applications available on such a mobile terminal and the reduced dimensions of its screen, today it is common to see this home page divided into a plurality of panels. The mobile terminal screen then enables the display of a panel from among a plurality of panels and the mobile terminal offers a navigation means enabling one to pass from one panel to another.

Each panel from the home page may contain icons enabling applications to be activated. An icon is a static graphic object that enables, when the user interacts with this icon, a corresponding application to be activated, with its full user interface. For example, when the mobile terminal screen is a touch screen, it is possible to activate an application with its full user interface by pressing a finger on the icon corresponding to the application.

Each home page panel may also contain graphical gadgets (or widgets, a contraction of window gadgets). A graphical gadget is a partial interface of an application, i.e., a graphical gadget does not occupy the entire screen and only provides a part of the functionalities of the application. Such a graphical gadget may be disposed as an icon on a panel. Therefore, it is an intermediary between an icon and an application launched with its full user interface. A graphical gadget is connected to a panel and enables an application to be activated with its full user interface, as an icon. It also has the dynamic character of the application and interacts with the user by providing the user with part of the functionalities offered by the application. Such graphical gadgets are found, for example, in the operating system for Android (registered trademark) mobile terminals developed by the Google Inc. company.

It also is common for the user of the terminal to be able to add new applications that he acquires and installs on his mobile terminal. Because of this, the number of graphic objects present on the panels of the home page, whether icons or widgets, constantly increases. It then becomes tiresome for the user to find his bearings in the midst of all these graphic objects and to rapidly access applications or more generally the functionalities that he wishes to activate.

Mitigating these different disadvantages from the prior art is desirable.

It is particularly desirable to provide a solution that enables a mobile terminal user to customize the man-machine interface of his mobile terminal so as to rapidly and easily access the applications that he wishes to activate. It is particularly desirable to provide a solution that enables this user to rapidly and easily access these applications via menus.

It is particularly desirable to provide a solution that is simple to implement at a low cost.

The invention relates to a mobile terminal comprising a man-machine interface comprising a plurality of panels in which graphic objects relative to the applications installed on the mobile terminal, each application being associated with at least one application category, may be placed. The mobile terminal comprises selective authorization means, for each panel under consideration, of placing at least one graphic object on said panel, depending on at least one application category associated with said panel.

By selectively authorizing placement of graphic objects on a panel, depending on the application category or categories associated with the panel under consideration, the user is helped in the customization of his mobile terminal such that he more easily finds his bearings in the man-machine interface of his mobile terminal, and more easily and quickly accesses the applications that he wishes to activate.

According to a particular embodiment, the mobile terminal is of the type comprising display means on a screen of a panel from among a plurality of panels and the selective authorization means are activated for the panel displayed on the screen.

Therefore, customization of the mobile terminal is facilitated in that the placement of graphic objects on a panel is made possible once this panel is displayed, which helps the user find visual cues for customizing the mobile terminal and prevents tiresome passages by various levels of configuration menus.

According to a particular embodiment, the display means are adapted to display a menu comprising graphic objects relative to applications installed on the mobile terminal, said menu being accessible from each panel, the mobile terminal comprises means to organize graphic objects from the menu according to the determined application category or categories.

Therefore, the menu accessible from the panel is also organized so as to facilitate access to applications of which the relative graphic objects are authorized to be placed on the panel.

According to a particular embodiment, the organization means are adapted to include in the menu only at least one graphic object relative to an application associated with at least one category in common with the determined application category or categories.

Therefore, only applications in which the relative graphic objects are authorized to be placed on the panel are accessible via the menu. The man-machine interface is thus homogeneous between the displayed panel and the menu accessible from this panel.

According to a particular embodiment, the menu comprising a plurality of graphic objects, the organization means are adapted to separate said graphic objects into a plurality of groups, depending on the determined application category or categories.

Therefore, all applications are accessible from each panel, the menu however being organized so as to facilitate access to certain applications depending on the application category or categories associated with the displayed panel.

According to a particular embodiment, a first group being constituted of graphic objects relative to applications associated with at least one category in common with the determined application category or categories, a second group being constituted of graphic objects enabling access to other applications, the display means are adapted to display the first group in a first area of the menu, closer to an edge of said menu, separating it from the panel displayed on the screen, than a second area of the menu intended for the second group.

Therefore, the distance to place a graphic object allowed on the displayed panel is reduced.

According to a particular embodiment, the mobile terminal comprises displacement means to drag at least one graphic object from the menu to the panel displayed on the screen.

Therefore, the placement of a graphic object allowed on the displayed panel is facilitated.

The invention also relates to a method implemented by a mobile terminal comprising a man-machine interface comprising a plurality of panels in which graphic objects relative to the applications installed on the mobile terminal, each application being associated with at least one application category, may be placed. The method comprises a selective authorization step, for each panel under consideration, of placing at least one graphic object on said panel under consideration, depending on at least one application category associated with said panel under consideration.

The invention also relates to a computer program, which may be stored on a support and/or downloaded from a communication network, in order to be read by a computer system or a processor. This computer program comprises instructions to implement the method mentioned above, when said program is executed by a computer system or a processor. The invention also relates to storage means comprising such a computer program.

The characteristics of the invention mentioned above, as well as others, will appear more clearly upon reading the following description of an example of embodiment, said description being made in relation to the attached drawings, among which:

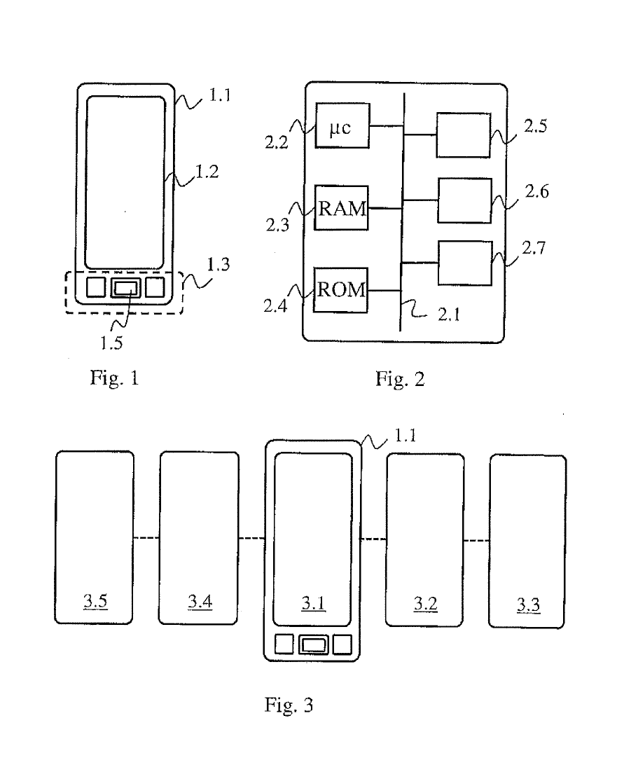

FIG. 1 illustrates a mobile terminal, with a screen, and in which the invention may be implemented;

FIG. 2 schematically illustrates the architecture of the mobile terminal from FIG. 1;

FIG. 3 schematically illustrates a home page of the mobile terminal from FIG. 1 divided into a plurality of panels;

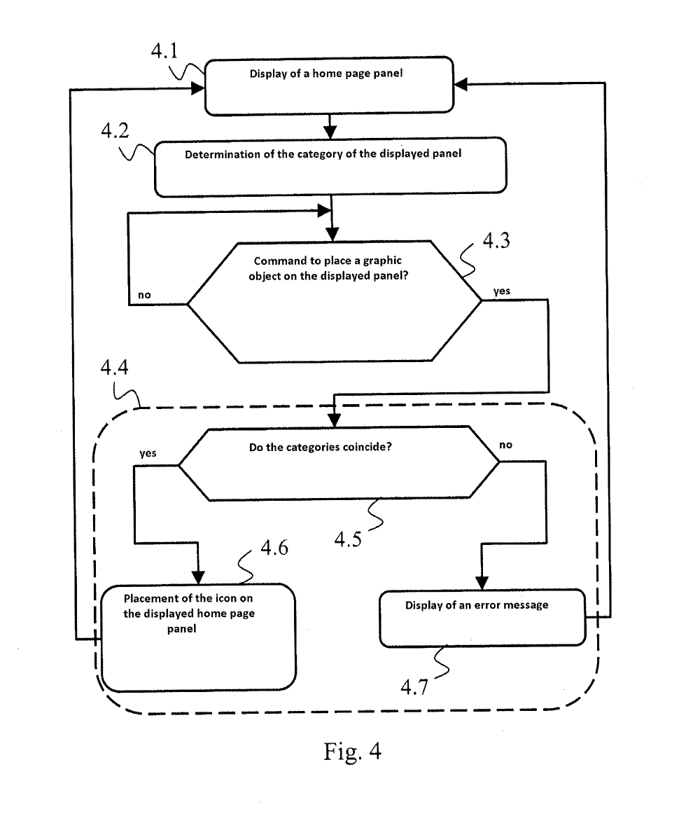

FIG. 4 schematically illustrates a home page panel management algorithm, such as implemented by the mobile terminal of FIG. 1 in an embodiment of the present invention;

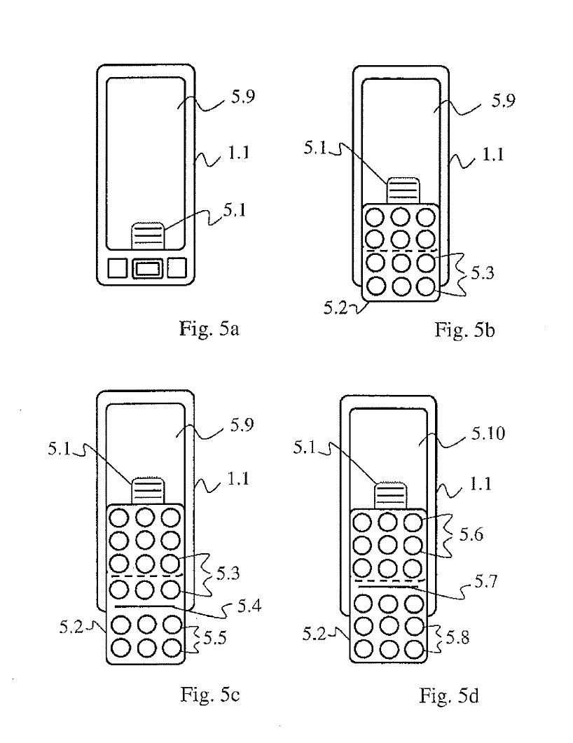

FIG. 5a schematically illustrates a home page panel from the mobile terminal of FIG. 1;

FIG. 5b schematically illustrates a first example of the menu accessible from a home page panel of the mobile terminal of FIG. 1;

FIG. 5c schematically illustrates a second example of the menu accessible from a home page panel of the mobile terminal of FIG. 1;

FIG. 5d schematically illustrates a third example of the menu accessible from a home page panel of the mobile terminal of FIG. 1;

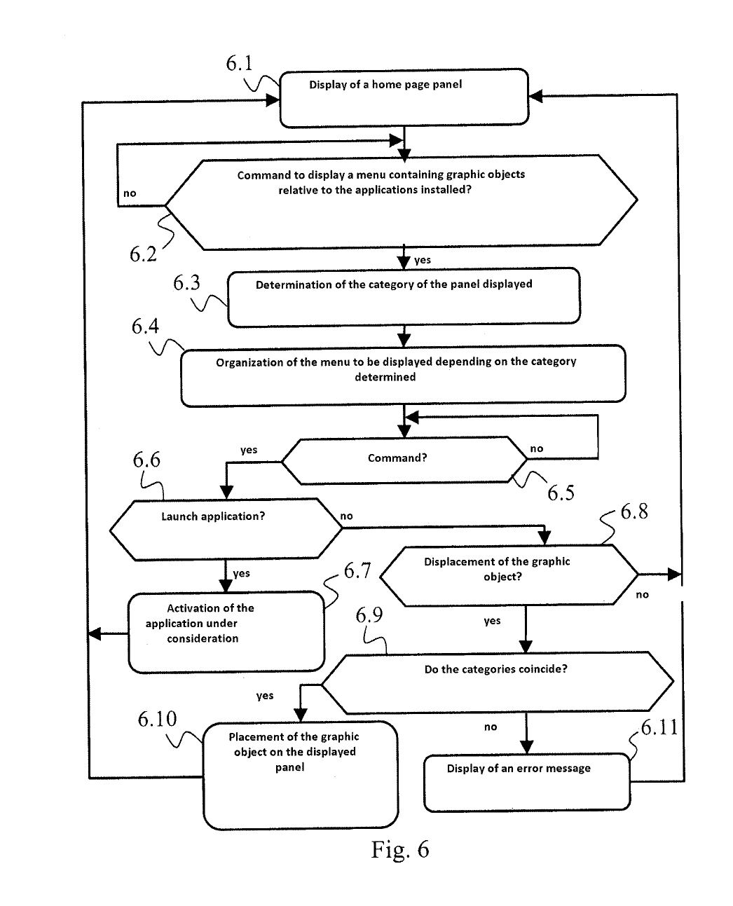

FIG. 6 schematically illustrates a menu management algorithm, such as implemented by the mobile terminal of FIG. 1 in an embodiment of the present invention.

So that a user of a mobile terminal with a screen may easily and rapidly access the applications installed on the terminal, categorizing the applications installed on the mobile terminal, and similarly categorizing the home page panels is proposed. Each panel may be classified in one or more categories, called application categories. In the same manner, an application may be classified in one or more application categories. It is also said that each panel and application has one or more associated application categories. Therefore, the mobile terminal selectively authorizes the placement of icons or widgets, or more generally graphic objects, depending on the application category or categories associated with the panel under consideration. For example, the mobile terminal only authorizes the placement of graphic objects that are from the same application category or categories as the panel under consideration. In another example, the mobile terminal only authorizes placement on a panel of graphic objects that correspond to applications associated with at least one application category in common with the panel under consideration.

In a particular embodiment, a selective authorization of the placement of graphic objects is only done in that relating to the panel displayed on the screen of the mobile terminal.

In a particular embodiment, a menu is accessible from each panel. This menu comprises graphic objects relative to the applications installed on the mobile terminal. For example, this menu comprises icons that enable the respective applications to be activated. The mobile terminal then organizes the graphic objects from the menu depending on the application category or categories associated with the displayed panel. Thus, by displaying a panel associated with a given application category, and by opening the menu, the mobile terminal, by its organization of graphic objects depending on the application category or categories associated with the displayed panel, enables the user to more quickly and easily access the applications that he wishes to activate. An example of organization of the menu may be to only place graphic objects relative to applications from the same application category or categories as that or those of the displayed panel. Another example of menu organization may be to only place, on one side, graphic objects relative to applications from the same application category or categories as that or those from the displayed panel and, on the other side, graphic objects relative to other applications.

FIG. 1 illustrates a mobile terminal in which the invention may be implemented.

A mobile terminal 1.1 conventionally comprises a screen 1.2 on which a user may see graphic objects relative to applications and interact with them. This interaction may be done directly if screen 1.2 is tactile or by means of a set of keys 1.3 or a keypad. In the rest of the description, screen 1.2 is considered to be a touch screen.

Mobile terminal 1.1 is for example a cellular radio telephone mobile terminal, a PDA personal digital assistant, a tablet type personal computer, etc. In a preferred embodiment, mobile terminal 1.1 is a cellular radio telephone mobile terminal.

FIG. 2 schematically illustrates the architecture of mobile terminal 1.1.

Mobile terminal 1.1 comprises, connected by a communication bus 2.1:
a processor, microprocessor, microcontroller (noted μc) or CPU (Central Processing Unit) 2.2;
a RAM (Random Access Memory) 2.3;
a ROM (Read Only Memory) 2.4;
a storage medium reader 2.5, such as an SD card (Secure Digital Card) reader;
interface means 2.6 with a communication network, such as for example a cellular radio telephone network; and
man-machine interface means 2.7, particularly enabling the screen 1.2 and set of keys 1.3 to be managed.

Microcontroller 2.2 is capable of executing the instructions loaded in RAM 2.3 from ROM 2.4, from an external memory (not represented), a storage support, such as an SD card or other, or from a communication network. When mobile terminal 1.1 is turned on, the microcontroller 2.2 is capable of reading from RAM 2.3 the instructions and of executing them. These instructions form a computer program. This computer program causes the implementation, by microcontroller 2.2, of part or all of the algorithms described below in relation to FIGS. 4 and 6.

Part or all of the algorithms described below in relation to FIGS. 4 and 6 may be implemented in software form by executing a set of instructions by a programmable machine, such as a DSP (Digital Signal Processor) or a microcontroller, such as microcontroller 2.2, or may be implemented in hardware form by a dedicated machine or component, such as an FPGA (Field-Programmable Gate Array) or an ASIC (Application-Specific Integrated Circuit).

FIG. 3 schematically illustrates a home page of the mobile terminal 1.1 divided into a plurality of panels.

When a user turns on mobile terminal 1.1, it typically displays a home panel 3.1 of a home page. The home page is divided into a plurality of panels 3.1, 3.2, 3.3, 3.4 and 3.5. Screen 1.2 of mobile terminal 1.1 enables the display of a single panel from among the plurality of panels and mobile terminal 1.1 offers a navigation means enabling passage from one panel to another.

The panels are categorized the same as the applications are categorized. For example, it is possible to classify panels and applications into contacts, recreation, purchases, multimedia, games, work, etc. application categories. The contacts application category may thus cover message exchange applications of the SMS (Short Message Service) or MMS (Multimedia Messaging Service) type or of the e-mail type. This contacts application category may also cover applications to access social network, etc., Internet sites.

It should be noted that a same application may be classified into several application categories, that a same panel may also be classified into several application categories and that two panels may also have at least one application category in common.

It is possible that the plurality of panels of the home page comprise one or more generic panels. Such panels have the conventional behavior of being able to authorize the placement of graphic objects independently from any application category.

It is for example possible to indicate with which application category or categories a panel is associated by using a theme for each application category, with for example a background displayed on the panel representing this theme. It is also possible to use, for each application category, a dominant color shade in the display of the panel. It is also possible to display on the panel, in the form of text, with which application category or categories it is associated.

Once the applications and panels are categorized, it is possible to selectively authorize the placement of graphic objects on the panels. Thus, it is for example possible to only authorize placement on a panel associated with a given application category icons and widgets that correspond to respective applications associated with this given application category.

Panels 3.1, 3.2, 3.3, 3.4 and 3.5, and the applications installed on mobile terminal 1.1, thus categorized, enable the user of mobile terminal 1.1 to more easily find his bearings within the home page and to more quickly access the applications that he wishes to activate.

FIG. 4 schematically illustrates a home page panel management algorithm, such as implemented by mobile terminal 1.1 in an embodiment of the present invention.

In a step 4.1, the mobile terminal 1.1 displays a home page panel.

In the next step 4.2, the mobile terminal 1.1 determines in which application category or categories the displayed panel is classified.

In the next step 4.3, the mobile terminal 1.1 determines if a command to place a graphic object on the displayed panel is detected. If such is the case, a step 4.4 is carried out, if not, step 4.3 is repeated.

Step 4.4 is then a selective step to authorize, by the mobile terminal 1.1, placement of the graphic object on the displayed panel.

In a particular embodiment, step 4.4 is broken down into steps 4.5, 4.6 and 4.7, starting with step 4.5.

During step 4.5, the mobile terminal 1.1 determines if the graphic object corresponds to an application with which the associated application category or categories coincide(s) with that or those of the displayed panel, such as determined in step 4.2. In other words, the mobile terminal 1.1 determines if the graphic object is from the same application category or categories as the displayed panel, or if the graphic object has an application category in common with the displayed panel. If the application category or categories of the application corresponding to the graphic object coincide(s) with the application category or categories associated with the displayed panel, step 4.6 is carried out; If not, step 4.7 is carried out.

During step 4.6, the mobile terminal 1.1 authorizes the placement of the graphic object on the displayed panel. Placement of the graphic object is then carried out. An icon or widget may thus be placed on this panel. By thus authorizing placement of icons and/or graphic objects on a panel only if their associated application categories coincide, the user is helped in the customization of his mobile terminal such that he more easily finds his bearings in the man-machine interface of his mobile terminal, and therefore more easily and quickly accesses the applications that he wishes to activate.

In a particular embodiment, each menu accessible from several panels is dynamically organized so as to facilitate and accelerate such customization of the man-machine interface.

In a particular embodiment, each menu accessible from several panels is dynamically organized so as to facilitate and accelerate access to applications that the user of the mobile terminal 1.1 wishes to activate.

The mobile terminal 1.1 thus organizes such menus according to the application category or categories associated with the panel displayed on screen 1.2.

These embodiments comprising a dynamic organization of the menu accessible from several panels are described below in relation to FIGS. 5a to 5d and FIG. 6.

FIG. 5a schematically illustrates a home page panel from the mobile terminal 1.1.

A home page panel 5.9 is displayed on screen 1.2. This panel 5.9 is one of panels 3.1, 3.2, 3.3, 3.4 or 3.5 of FIG. 3. Superimposed on one part of panel 5.9 is displayed a graphic object 5.1. This graphic object 5.1 is positioned against an edge of screen 1.2. The object is hooked to this screen 1.2 edge. This graphic object 5.1, when manipulated, enables a menu to be accessed. This graphic object 5.1 is called a tab in the rest of the description. To access the menu, the mobile terminal 1.1 user places his finger on the touch

screen 1.2 at the location where tab 5.1 is displayed. The mobile terminal 1.1 user maintains the pressure exerted by his finger on the touch screen 1.2 and slides his finger so as to unhook the tab 5.1 from the edge of the screen 1.2 to which it is hooked. The user pulls on tab 5.1. This action has the effect of exposing a menu composed of icons associated with the applications installed on the mobile terminal. In the same manner as the icons placed on the home page panel of mobile terminal 1.1, the icons placed in this menu conventionally enable the applications to which they respectively correspond to be activated.

FIGS. 5b to 5d schematically illustrate a menu, accessible via screen 1.2, in different situations of organizing the icons making up the menu.

FIG. 5b schematically illustrates a first example of the menu accessible from a home page panel of the mobile terminal 1.1 according to an embodiment of the present invention.

Panel 5.9, tab 5.1 of FIG. 5a are found in FIG. 5b. The mobile terminal 1.1 user has pulled on tab 5.1, as described above in relation to FIG. 5a. One part of menu 5.2 is then displayed on screen 1.2. This part of the menu is hooked to tab 5.1 and covers panel 5.9 between tab 5.1 and the edge of the screen to which tab 5.1 is hooked in FIG. 5a. The remaining part of menu 5.2, i.e., that which is not displayed on screen 1.2, is accessible by continuing to pull on tab 5.1.

Menu 5.2 thus exposed, fully or partially, is composed of icons 5.3. The icons 5.3 correspond to applications with which the associated application category or categories coincide(s) with the application category or categories associated with panel 5.9. No icon corresponding to an application with which the associated application category or categories do not or does not coincide with the application category or categories associated with panel 5.9 is present in menu 5.2.

Thus, when the mobile terminal user 1.1 pulls on tab 5.1 and causes menu 5.2 to appear, he has access only to graphic objects relative to the respective applications associated with the application categories that coincide with that or those associated with the displayed panel 5.9. Thus, to activate an application, the user causes the display, by mobile terminal 1.1, of a panel that is associated with at least one application category that coincides with that or those of the application to be activated. If this panel does not comprise a graphic object, such as an icon or widget, enabling the application to be activated, the user may pull on tab 5.1 to cause menu 5.2 to appear and thus easily access a graphic object enabling the application to be activated. The procedure to activate the application is thus simplified.

FIG. 5c schematically illustrates a second example of the menu accessible from a home page panel of the mobile terminal 1.1 according to an embodiment of the present invention.

Panel 5.9, tab 5.1 of FIG. 5a and menu 5.2 of FIG. 5b are found in FIG. 5c. The mobile terminal 1.1 user has pulled on tab 5.1, as described above in relation to FIG. 5a. One part of menu 5.2 is then displayed on screen 1.2. This part of the menu is hooked to tab 5.1 and covers panel 5.9 between tab 5.1 and the edge of the screen to which tab 5.1 is hooked in FIG. 5a. The remaining part of menu 5.2, i.e., that which is not displayed on screen 1.2, is accessible by continuing to pull on tab 5.1.

Menu 5.2 thus exposed, fully or partially, is composed of two separate groups: a first group is formed with icons 5.3 and a second group is formed with icons 5.5. The two groups are possibly separated by a separator 5.4. As with FIG. 5b, the icons 5.3 correspond to applications with which the associated application category or categories coincide(s) with the application category or categories associated with panel 5.9. Icons 5.5 correspond to applications with which the associated application category or categories do not or does not coincide with the application category or categories associated with panel 5.9.

Preferentially, the first group of icons is displayed in an area of menu 5.2 closer to an edge separating it from the displayed panel 5.9, than a second area of menu 5.2 intended for the second group. Preferentially, the first group is displayed in an area of menu 5.2 closer to the edge of menu 5.2 where tab 5.1 is placed.

Thus, when the mobile terminal user 1.1 pulls on tab 5.1 and causes menu 5.2 to appear, he first has access to graphic objects relative to the respective applications associated with the application categories that coincide with that or those associated with the displayed panel 5.9. Thus, to activate an application, the user causes the display, by mobile terminal 1.1, of a panel with which the associated application category or categories coincide(s) with that or those of the application to be activated. If this panel does not comprise a graphic object, such as an icon or widget, enabling the application to be activated, the user may pull on tab 5.1 to cause menu 5.2 to appear and thus easily access a graphic object enabling the application to be activated. The procedure to activate the application is thus simplified. In this embodiment, the user may thus activate an application with which the associated application category or categories do not or does not coincide with that or those associated with the displayed panel 5.9. He may thus, from each panel, activate any application installed on the mobile terminal 1.1, the activation of the application with which the associated application category or categories coincide(s) with that or those associated with the displayed panel 5.9 being facilitated.

FIG. 5d schematically illustrates a third example of the menu accessible from a home page panel of the mobile terminal 1.1 according to an embodiment of the present invention.

Tab 5.1 of FIG. 5a and menu 5.2 of FIG. 5b are found in FIG. 5d. A panel 5.10, different from panel 5.9 of FIG. 5c, is displayed on the screen. This panel 5.10 differs from panel 5.9 in that it is associated with one or more application category or categories, at least one of which differs from that or those associated with panel 5.9.

Two groups of icons are also found, as with FIG. 5c. A third group is formed with icons 5.6 and a fourth group is formed with icons 5.8. The two groups are possibly separated by a separator 5.7. As with FIG. 5c, the icons 5.6 correspond to applications with which the associated application category or categories coincide(s) with the application category or categories associated with panel 5.10, and icons 5.8 correspond to applications with which the associated application category or categories do not or does not coincide with the application category or categories associated with panel 5.10. The first and second groups of icons described in relation to FIG. 5c and the third and fourth groups described in relation to FIG. 5d differ. In fact, given that panels 5.9 and 5.10 are associated with different application categories, menu 5.2 takes a different form when it is displayed from panel 5.10 than the form it takes when it is displayed from panel 5.10. The organization of icons in menu 5.2 is thus dynamic and depends on the application category or categories associated with the displayed panel.

Menu 5.2 may also be used to place, on the panel displayed on screen 1.2, graphic objects relative to the applications installed on mobile terminal 1.1. The placement of these graphic objects on the displayed panel is done according to the application category or categories associated with the displayed panel.

By repeating the illustrative examples of FIGS. 5b and 5c, to be able to place an icon 5.3 on the panel 5.9, the user of mobile terminal 1.1 places his finger on the touch screen 1.2 at the location where relevant icon 5.3 is displayed. The user then maintains the pressure exerted by his finger on touch screen 1.2. Once a predefined time has elapsed, menu 5.2 disappears and the display repeats the form presented above with relation to FIG. 5a, except that icon 5.3 under consideration is still displayed under the finger of the user. The user maintains the pressure exerted by his finger on touch screen 1.2 and slides his finger to reach a location on panel 5.9 where he wishes to position the icon 5.3 under consideration. The user may then remove his finger from the touch screen 1.2 and the icon 5.3 under consideration is henceforth placed in panel 5.9 at the location where the user positioned the icon.

In this particular embodiment, the mobile terminal 1.1 thus comprises displacement means to drag a graphic object from menu 5.2 to displayed panel 5.9. It is also possible to thus drag several graphic objects from menu 5.2 to the displayed panel 5.9.

In a first embodiment, a graphic object that is displaced from menu 5.2 to displayed panel 5.9 disappears from menu 5.2.

In a second embodiment, a graphic object that is displaced from menu 5.2 to displayed panel 5.9 remains present in menu 5.2. A copy of this graphic object is then created during its placement on the displayed panel 5.9.

Mobile terminal 1.1 authorizes the placement of icon 5.3 on the displayed panel 5.9, since icon 5.3 is associated with one or more application category or categories that coincide(s) with that or those associated with the displayed panel 5.9. Mobile terminal 1.1 does not authorize the placement of icon 5.5 on the displayed panel 5.9, since icon 5.5 is associated with one or more application category or categories that do not coincide(s) with that or those associated with the displayed panel 5.9.

The description above for placing icons on a panel also applies to widgets. Menu 5.2 may thus either comprise graphic objects representing icons and/or graphic objects representing widgets. It is then possible to drag a graphic object representing a widget to the displayed panel to install this widget onto the panel, insofar as their application categories coincide.

FIG. 6 schematically illustrates a menu management algorithm, such as implemented by the mobile terminal 1.1 in an embodiment of the present invention.

In a step 6.1, the mobile terminal 1.1 displays a home page panel.

In the next step 6.2, mobile terminal 1.1 determines if a command to display a menu containing graphic objects relative to installed applications is detected. If such is the case, step 6.3 is carried out; If not, step 6.2 is repeated. Such a command corresponds, for example, to the action according to which the user pulls tab 5.1, as described above in relation to FIGS. 5a and 5b.

During step 6.3, the mobile terminal 1.1 determines in which application category or categories the displayed panel is classified.

In the next step 6.4, mobile terminal 1.1 organizes the graphic objects in the menu to be displayed, depending on the application category or categories determined in step 6.3. Mobile terminal 1.1 organizes, for example, the menu to be displayed as described above with relation to FIGS. 5b or FIG. 5c. Mobile terminal 1.1 then displays the menu resulting from this organization of graphic objects.

In the next step 6.4, mobile terminal 1.1 determines if a command corresponding to a user action is detected. If such is the case, step 6.6 is carried out; If not, step 6.4 is repeated.

During step 6.6, mobile terminal 1.1 determines if the command detected in step 6.5 corresponds to an application activation. If such is the case, the command affects a graphic object and step 6.7 is carried out; If not, step 6.8 is carried out.

During step 6.7, mobile terminal 1.1 activates the application to which the graphic object affected by the command corresponds. Step 6.1 is then repeated.

During step 6.8, mobile terminal 1.1 determines if the command detected in step 6.5 corresponds to a graphic object displacement. If such is the case, step 6.9 is carried out; If not, the command relates to a processing carried out by another algorithm and step 6.1 is repeated.

During step 6.8, mobile terminal 1.1 determines if the graphic object affected by the displacement corresponds to an application with which the associated application category or categories coincide(s) with that or those of the displayed panel. The mobile terminal then carries out a selective step to authorize placement of the graphic object on the displayed panel. If mobile terminal 1.1 authorizes the placement of the graphic object on the displayed panel, step 6.10 is carried out; If not, step 6.11 is carried out.

During step 6.10, mobile terminal 1.1 validates the placement of the graphic object on the displayed panel, and step 6.1 is repeated.

During step 6.11, an error message is displayed, placement of the graphic object on the displayed panel is not validated, and step 6.1 is repeated.

In an embodiment of the invention, instead of displaying an error message in steps 4.7 and 6.11, the mobile terminal 1.1 proposes to the user a selection of at least one panel in which the associated application category or categories coincide(s) with that or those of the graphic object under consideration. The user may thus choose a panel in this selection and successfully complete the operation to place the graphic object under consideration. In addition, his understanding of the application categories associated with the panels and with the applications is improved.

By thus authorizing placement of icons and/or graphic objects on a panel only if their associated application categories coincide, the user is helped in the customization of his mobile terminal such that he more easily finds his bearings in the man-machine interface of his mobile terminal, and therefore more easily and quickly accesses the applications that he wishes to activate. The menu accessible from the panel is also organized so as to facilitate the placement of graphic objects on a suitable panel.

1. A mobile terminal (1.1) comprising a man-machine interface comprising a plurality of panels (3.1;3.2;3.3;3.4;3.5) on which may be placed graphic objects relative to the applications installed on the mobile terminal, said mobile terminal comprising means to display on a screen (1.2) a panel from among said plurality of panels, each application being associated with at least one application category, the display means being adapted to display a menu (5.2) comprising graphic objects (5.3;5.5) relative to the applications installed on the mobile terminal and from which the graphic objects relative to the applications installed on the mobile terminal may be installed on the panel displayed on the screen,
said mobile terminal also comprising:
selective authorization means for placing at least one graphic object on said panel displayed on the screen, depending on at least one application category associated with said panel displayed on the screen; and
means to organize graphic objects from the menu depending on the application category or categories associated with said panel displayed on the screen.

2. The mobile terminal (1.1) according to claim 1, in which the organization means are adapted to include in the menu only at least one graphic object relative to an application associated with at least one category in common with the application category or categories associated with said panel displayed on the screen.

3. The mobile terminal (1.1) according to claim 1, in which the organization means are adapted to separate into a plurality of groups said graphic objects from the menu, depending on the application category or categories associated with said panel displayed on the screen.

4. The mobile terminal (1.1) according to claim 3, in which, a first group being constituted of graphic objects relative to applications associated with at least one category in common with the application category or categories associated with said panel displayed on the screen, a second group being constituted of graphic objects enabling access to other applications, the display means are adapted to display the first group in a first area of the menu, closer to an edge of said menu, separating it from the panel displayed on the screen, than a second area of the menu intended for the second group.

5. The mobile terminal (1.1) according to claim 1, comprising displacement means to drag at least one graphic object from the menu to the panel displayed on the screen.

6. The mobile terminal (1.1) according to claim 5, the screen being tactile for the means to detect a press, called a long press, by the user on at least one graphic object from the menu for a predefined duration,
and, when a long press is detected by the detection means, the display means being adapted to cause the menu to disappear with the exception of the graphic object or objects on which the long press is detected,
And selective placement authorization means are adapted to place the graphic object or objects on which the long press is detected at a location on the displayed panel where the graphic object or objects on which the long press is detected are dragged by the displacement means.

7. A method implemented by a mobile terminal (1.1) comprising a man-machine interface comprising a plurality of panels (3.1;3.2;3.3;3.4;3.5) on which graphic objects relative to the applications installed on the mobile terminal, each application being associated with at least one application category, may be placed,
The method comprising a step to display on a screen (1.2) a panel from among said plurality of panels, a step to display on the screen a menu (5.2) comprising graphic objects (5.3;5.5) relative to the applications installed on the mobile terminal and from which the graphic objects relative to the applications installed on the mobile terminal may be installed on the panel displayed on the screen, a step of selectively authorizing the placement of at least one graphic object on said panel displayed on the screen, depending on at least one application category associated with said panel displayed on the screen and a step of organizing graphic objects from the menu depending on the application category or categories associated with said panel displayed on the screen.

8. A computer program, characterized in that the program comprises instructions for implementing, by a mobile terminal, the method according to claim 7, when said program is executed by a processor of said mobile terminal.

9. Storage means, characterized in that the means store a computer program comprising instructions for implementing, by a mobile terminal, the method according to claim 7, when said program is executed by a processor of said mobile terminal.
